(19) United States
(12) Patent Application Publication
(10) Pub. No.: US 2007/0248243 A1
(43) Pub. Date: Oct. 25, 2007

(54) Device and method of detecting gradual shot transition in moving picture

(75) Inventors: San Ko, Seoul (KR); Ji Yeun Kim, Seoul (KR); Young Su Moon, Seoul (KR); Sang Kyun Kim, Yongin-si (KR); Doo Sun Hwang, Seoul (KR); Jin Guk Jeong, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/521,318

(22) Filed: Sep. 15, 2006

(30) Foreign Application Priority Data
Apr. 25, 2006 (KR) 10-2006-0037330

(51) Int. Cl. G06K 9/00; G06K 9/46

(52) U.S. Cl. 382/103; 382/195

(57) ABSTRACT

An apparatus for and a method of detecting a gradual shot transition in a moving picture The method includes: setting at least one feature point of a frame included in the moving picture, tracking the set at least one feature point, and setting a feature point of a subsequent frame, from the tracked at least one feature point; calculating a feature value corresponding to each feature point of each of the frames; and comparing corresponding feature values of corresponding feature points which are tracked for each of the frames, and determining that a gradual shot transition between the frames occurs when the comparison value is greater than a predetermined threshold value.

### CROSS-REFERENCE TO RELATED APPLICATION

This application claims the benefit of Korean Patent Application No. 10-2006-0037330, filed on Apr. 25, 2006, in the Korean Intellectual Property Office, the disclosure of which is incorporated herein by reference.

### BACKGROUND OF THE INVENTION

1. Field of the Invention

The present invention relates to a device for and a method of detecting a gradual shot transition in a moving picture, and more particularly, to a device for and a method of detecting a gradual shot transition in a moving picture, based on a comparison value between set feature points of frames of a moving picture.

2. Description of Related Art

Currently, in the information technology (IT) field, various video media are actively provided. Starting with new video services such as satellite Digital Multimedia Broadcasting (DMB), terrestrial DMB, data broadcasting, Internet broadcasting, and in the IT field including communications, Internet services, and digital devices, the video on demand industry continues to expand.

The present “era of portable TV” started with the satellite/terrestrial DMB, and mobile telecom companies then started to extend video on demand service via data broadcasting of their own companies via consortiums with content companies. Also, Internet portal sites provide to users via sites of their own company and cooperation sites, homemade videos or videos secured via the consortiums with the content companies.

In addition, TV portal sites currently provided are predecessors of Internet TV and implement a service in which users can watch movies or dramas provided by the portal sites by downloading or streaming as video on demand (VOD) via a PC, a notebook PC, and a mobile communication terminal. Further, Triple Play Service (TPS), in which the Internet, broadcasting, and telephonic communication are provided together over a single broadband connection is expected to increase, and the demand for video content will increase even more.

As a result of this continuing expansion of video content delivery, younger generations are so familiar with this video culture that video is not an optional feature but an essential feature. In response, industries related to video are seen as the most competitive of all IT fields. Accordingly, a market of video replay terminals such as DMB terminals and Portable Multimedia Players (PMPs) continues to expand.

Mobile telecom companies competitively release satellite DMB phones and terrestrial DMB phones, and MP3 player companies release various models of PMPs supporting DMB. Currently, an MP3 player is also equipped with a minimal LCD as a display unit, whose size is 2 inches, thereby supporting the function of replaying a video. The various video support terminals described need to be developed into convergence products supporting all types of video services in one terminal.

As described above, due to development of video services and performance of terminals, the demand of users pursuing convenience is increasing. Specifically, users do not request terminals to simply replay videos anymore but request video services supporting various additional functions.

For example, there are summary video services. Summary video services are services generating a summary image of a video, and providing the summary image to a user when the user has no time to watch an entire video of several hours. Since summary video services are suitable for everyday use by busy people watching videos via their own portable device while commuting during rush hour or on a short break, summary video services are expected to increase in the future.

In summary video services, segmenting a video for each shot is critical. In a moving picture, a shot is a fixed frame section which is classified as a single camera motion when taking a moving picture. Also, the shot is a basic processing unit which is used when dividing a moving picture by content. A scene change detection technology is critical for scene indexing. When making a table of content based on a content of a moving picture, summarizing the content of the moving picture, and editing the moving picture according to the content, the scene change detection technology provides boundary information between shots of the moving picture.

A scene change detection technology according to a conventional art calculates a difference metric between neighboring frames as a derivation metric compares the difference metric with a predetermined threshold value, and thereby may determine whether a scene change occurs in a current frame.

However, according to the conventional scene change detection technology, a gradual shot transition may not be accurately detected. A scene change comes in two types; an abrupt shot transition and a gradual shot transition. The abrupt transition is a shot transition which is abruptly converted from one shot to another shot in a predetermined frame. The gradual shot transition indicates a shot transition which is overlapped with another shot throughout many frames and gradually converted.

FIG. 1 illustrates when a change of a subject form, which is shown in a frame according to a location movement of a camera, is incorrectly detected as a gradual shot transition according to a conventional art.

When a camera taking a moving picture moves and a position of a subject is changed, subject forms which are shown in a first frame 110 and a second frame 120 may be shown as FIG. 1. In this instance, a change of the subject shown in the frame is simply caused by the location movement of the camera, which is not a gradual shot transition.

However, when a scene change is detected according to the conventional art, the change of the frame due simply to the location movement of the camera may be incorrectly detected as the gradual shot transition. Specifically, as illustrated in FIG. 1, a ‘www’ shape indicated in a sub-frame 4 114 of the first frame 110 may be indicated in a sub-frame 3 123 of the second frame 120 according to the location movement of the camera.

In this instance, according to the conventional art, a local comparison method which compares the subject form which is taken in the sub-frame 4 114 of the first frame 110 with the subject form which has been taken in the sub-frame 4 124 of the second frame 120 is used. Also, a method of comparing changes of feature values of both the first frame 110 and the second frame 120 is used. Accordingly, changes of the feature values of an entire frame and the sub-frame may be erroneously determined that the gradual shot transition between the first frame 110 and the second frame 120 occurs.

As described above, in the conventional art, entire frames of two images which are subjects of comparison or information which is obtained in a same position are simply compared, and a degree of the change is measured. Accordingly, a feature value in an unmatched corresponding relationship are compared, and an inaccurate result may be obtained.

Also, when a shot transition is detected by using a global feature value of the frame, an accurate result may not be obtained due to a mutual interference of positions which do not correspond to each other. Also, since an accurate corresponding relationship of the frames may not be determined, unnecessary information may be used. Accordingly, a processing speed of the shot transition may be decreased. Thus, development of more accurate and efficient gradual shot transition in a moving picture is needed.

### BRIEF SUMMARY

An aspect of the present invention provides a device for and a method of detecting a gradual shot transition in a moving picture, which track a feature point which is set in a predetermined frame and set a feature point of another frame, and thereby may compare a substantially corresponding location of each frame.

An aspect of the present invention also provides a device and a method of detecting a gradual shot transition in a moving picture, which compare local information including a feature value around a feature point of each frame, determine whether a gradual shot transition occurs, and thereby may prevent a mutual interference of positions which do not correspond to each other when comparing the feature values of an entire frame.

An aspect of the present invention also provides a device and a method of detecting a gradual shot transition in a moving picture, which compare a feature value around a feature point which is set in a frame, not a feature value of an entire frame, select necessary information in each frame, and thereby may obtain an accurate result with improved speed.

According to an aspect of the present invention, there is provided a method of detecting a gradual shot transition in a moving picture, the method including:.

According to another aspect of the present invention, there is provided an apparatus for detecting a gradual shot transition in a moving picture, the apparatus including: a feature point control unit setting at least one feature point of a frame included in the moving picture, tracking the set at least one feature point, and setting a feature point of a subsequent frame, from the tracked at least one feature point; a feature value calculation unit calculating a feature value corresponding to each feature point of each of the frames; and a gradual transition detection unit comparing corresponding feature values of corresponding feature points which are tracked for each of the frames, and determining that a gradual shot transition between the frames occurs when the comparison value is greater than or equal to a threshold value

According to another aspect of the present invention, there is provided a computer-readable recording medium storing a program for implementing the aforementioned method.

According to another aspect of the present invention, there is provided an apparatus for detecting a gradual shot transition between frames in a moving picture, the device including: a feature point control unit setting a feature point of a first frame of the moving picture, tracking the set feature point in the first frame, and setting a feature point of a second frame following the first frame, based on the tracked feature point set in the first frame; a feature value calculation unit calculating feature values around each set feature point; and a gradual transition detection unit determining whether a shot transition has occurred between the first and second frames by comparing the feature values and determining that a gradual shot transition occurs when a difference between the feature values is not less than a threshold value.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 illustrates when a change of a subject form which is shown in a frame according to location movement of a camera is incorrectly detected as a gradual shot transition according to a conventional art;

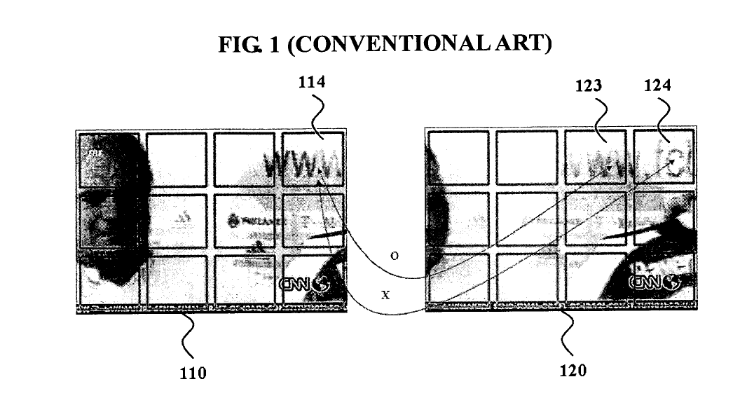

FIG. 2 is a block diagram illustrating a configuration of a device for detecting a gradual shot transition in a moving picture according to an embodiment of the present invention;

FIG. 3 is a diagram illustrating frames which are segmented into sub-frames, and a feature point is set according to an embodiment of the present invention;

FIG. 4 is a diagram illustrating frames of a moving picture in which a gradual shot transition occurs according to an embodiment of the present invention;

FIG. 5 is a flowchart illustrating a method of detecting a gradual shot transition in a moving picture according to an embodiment of the present invention; and

FIG. 6 is an internal block diagram of a general-purpose computer which can be adopted for implementing the method for capturing of the multi-channel image signal according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

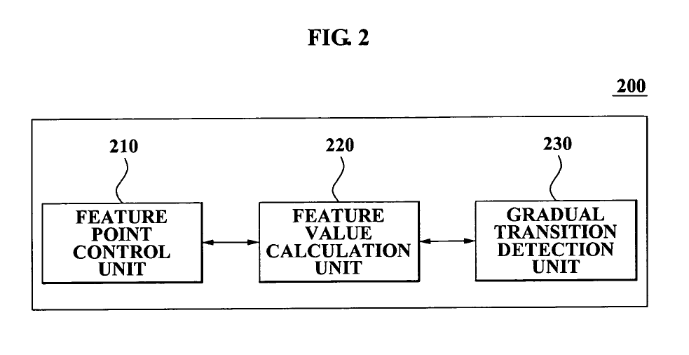

FIG. 2 is a block diagram illustrating a configuration of a device for detecting a gradual shot transition in a moving picture 200 according to an embodiment of the present invention.

The device for detecting a gradual shot transition in a moving picture 200 according to an embodiment of the present invention includes a feature point control unit 210, a feature value calculation unit 220, and a gradual transition detection unit 230.

The feature point control unit 210 sets at least one feature point of a predetermined frame included in the moving picture, tracks the at least one feature point set in the predetermined frame and sets a feature point of a subsequent frame after the predetermined frame, from (i.e., based on) a the tracked at least one feature point of the first frame.

Specifically, the feature point control unit 210 sets the at least one feature point of a particular frame of frames included in the moving picture which will be used to detect the gradual shot transition. The frame in which the feature point is set may be a first frame of the moving picture, or a first frame of a subsequent shot shortly after a predetermined shot transition is detected.

The feature point control unit 210 may set the at least one feature point of the frame by using a Harris-Corner detector or a scale invariant feature transform (SIFT) method. Also, the feature point control unit 210 may perform an operation to set the feature point by using various other types of known feature point setting methods as well as the Harris-Corner detector and SIFT method.

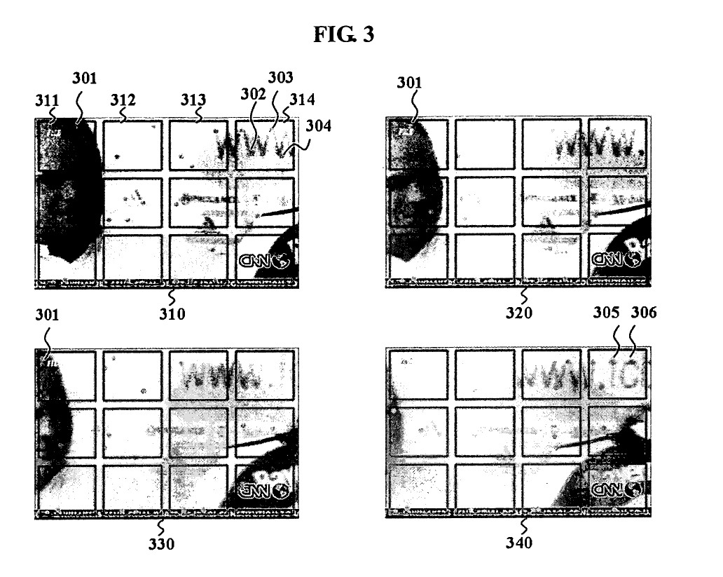

The feature point control unit 210 segments the predetermined frame into a plurality of sub-frames to set the at least one feature point. Also, the feature point control unit 210 may set the at least one feature point so that each of the sub-frames includes at least one feature point. This will be described in detail with reference to FIGS. 2 and 3.

FIG. 3 is a diagram illustrating 4 frames which are segmented into sub-frames, and set feature points according to an embodiment of the present invention.

FIG. 3 illustrates 4 frames of a shot which a subject form moves. In this instance, the subject form which is being recorded moves in relation to a target location of a camera. As illustrated in a first frame 310 in FIG. 3, the feature point control unit 210 may segment the first frame 310 into twelve sub-frames in total.

According to the present embodiment, the feature point control unit 210 may segment the first frame 310 into a 1-1 sub-frame 311, a 1-2 sub-frame 312, a 1-3 sub-frame 313, a 1-4 sub-frame 314, a 1-5 sub-frame, a 1-6 sub-frame, a 1-7 sub-frame, a 1-8 sub-frame, a 1-9 sub-frame, a 1-10 sub-frame, a 1-11 sub-frame, and a 1-12 sub-frame based on a position of each of the sub-frames.

As described above, after segmenting the first frame 310 into the twelve sub-frames, the feature point control unit 210 may set the at least one feature point in the first frame so that each of the sub-frames includes at least one feature point. The above-described feature point setting method may be applied to the Harris-Corner detector or the SIFT method. Also, the above-described feature point setting method may be used as a method to disperse feature points throughout a frame.

When setting the feature point of the first frame 310 is completed, the feature point control unit 210 may track the feature points which are set in the first frame 310, and set feature points of the second frame 320. Specifically, the feature point control unit 210 may set locations of the feature points of the second frame 320 corresponding to locations of each of the feature points which are set in the first frame 310 and tracked.

Also, the feature point control unit 210 may track the feature points which are set in the second frame 320, and set feature points of the third frame 330. Also, the feature point control unit 210 may track the feature points which are set in the third frame 330, and set feature points of the fourth frame 340.

Also, according to another embodiment of the present invention, the feature point control unit 210 may track and set the feature points of the third frame 330 and fourth frame 340 from the first frame 310 in the same way as in the second frame 320.

The feature point control unit 210 may respectively track the feature points which are set in each of the frames by using a Lucas-Kanade feature tracker. Also, the feature point control unit 210 may track the feature points by using other various known types of tracking methods.

When a number of feature points in a background frame is set to a number which is less than a predetermined number according to a change of the subject form shown in a frame, the feature point control unit 210 may generate a new feature point of the frame. Specifically, an M number of feature points of the first frame 310 is set. Then, when a number of feature points of a K^{th} frame which is set by tracking the M number of the feature points is set as the number which is less than the predetermined number, the feature point control unit 210 may generate at least one new feature point of the K^{th} frame so that the K^{th} frame has the M number of the feature points.

As illustrated in FIG. 3, the subject form indicated in each frame changes with time. Accordingly, a portion of the feature point which is set in the first frame 310 may not be tracked in the fourth frame. As an example, a feature point 1 301 which is set in the 1-1 sub-frame 311 of the first frame 310 may be tracked and set in the second frame 320 and the third frame 330. However, the feature point 1 301 may not be tracked in the fourth frame 340 since the subject form is not displayed. Accordingly, as time passes, the number of the feature points may be gradually reduced. When a number of set feature points is sharply reduced, the feature value of each of the frames may not be accurately calculated.

To avoid this potential for miscalculation, when the number of the feature point is reduced below the predetermined number, the feature point control unit 210 may generate a new feature point. As a non-limiting example, when the number of the feature points which are initially set in the first frame 310 is forty, after time passes while serially tracking the feature points, the number of the feature points which are set in the fourth frame 340 may have become less than twenty, for example, nineteen. In this instance, the feature point control unit 210 may newly set twenty one feature points so that the number of the feature points which are set in the fourth frame 340 becomes forty. A feature point 5 305 and a feature point 6 306 in the fourth frame 340 in FIG. 3 may be newly set feature points.

As described above, the feature point control unit 210 according to the present embodiment adjusts for a reduction of the number of the feature points as time passes. Also, the feature point control unit 210 always sets the feature points to be the predetermined number in all frames. Accordingly, the feature point control unit 210 may accurately calculate a feature value of the frame at all time.

Referring again to FIG. 2, the feature value calculation unit 220 calculates a feature value corresponding to each feature point of each of the frames. Specifically, the feature value calculation unit 220 may calculate the feature value around the feature point. The feature value may be at least one of a hue-saturation-value (HSV) histogram, a red-green-blue (RGB) histogram, a YCbCr histogram, a hue-lightness-saturation (HLS) histogram, a homogeneous texture, and a gabor texture.

A gradual shot transition detection unit 230 compares feature values of feature points which are tracked for each of the frame and correspond to each other. When the comparison value (i.e., the difference between the compared feature values) is greater than or equal to a predetermined threshold value, the gradual transition detection unit 230 determines that a gradual shot transition between the frames occurs. Specifically, the gradual transition detection unit 230 compares feature values of feature points which are calculated by the feature value calculation unit 220 for each frame, and may determine whether the gradual shot transition of each of the frames occurs.

The gradual transition detection unit 230 compares a feature value of a feature point of a first frame with a feature value of a feature point of a K^{th} frame, and may determine whether the gradual shot transition occurs. Specifically, after comparing the feature value of the feature point of the first frame with the feature value of the feature point of the K^{th} frame, the gradual transition detection unit 230 calculates a first comparison value, and compares the first comparison value with a predetermined threshold value. When the first comparison value is greater than or equal to the predetermined threshold value, the gradual transition detection unit 230 may determine that the gradual shot transition of the first frame occurs in the K^{th} frame.

Also, the gradual transition detection unit 230 compares a feature value of a feature point of each of the first through K^{th} frames with a feature value of a feature point of each of 1+N^{th} through K+N^{th} frames, and may determine that the gradual shot transition of the first frame occurs in the 1+N^{th} frame.

Specifically, the gradual transition detection unit 230 compares the feature value of the feature point of the first frame with the feature value of the feature point of the 1+N^{th} frame, and may calculate a first comparison value. Also, the gradual transition detection unit 230 compares a feature value of a feature point of a second frame with a feature value of a feature point of a 2+N^{th} frame, and may calculate a second comparison value. Also, the gradual transition detection unit 230 compares a feature value of a feature point of a third frame with a feature value of a feature point of a 3+N^{th} frame, and may calculate a third comparison value. As explained above, the gradual transition detection unit 230 compares a feature value of a feature point of the K^{th} frame with a feature value of a feature point of a K+N^{th} frame, and may calculate a K^{th} comparison value.

Specifically, the gradual transition detection unit 230 may compare a feature value of a feature point of each of the first through K^{th} frames with a feature value of a feature point of each of the frames which are separated by an N number of frames. In this instance, when a predetermined number of comparison values, among the first comparison value through the K^{th} comparison value, is greater than or equal to the threshold value, the gradual transition detection unit 230 may determine that the gradual shot transition of the first frame occurs in the 1+N^{th} frame. Specifically, frames from the first frame to the 1+N^{th} frame may be set as one shot, and another shot may correspond between the 1+N^{th} frame to the K+N^{th} frame. In this instance, the gradual shot transition from the one shot occurs within the other shot. Accordingly, when comparing feature values of feature points of a plurality of frames, the gradual shot transition may be more accurately detected than in the conventional art.

As described above, a device for detecting a gradual shot transition in a moving picture 200 uses a feature value of a feature point of which is set by tracking a feature point of a previous frame, and thereby may overcome a drawback of the conventional art. As an example, referring to FIG. 3, positions of a feature point 2 302, a feature point 3 303, and a feature point 4 304 which are set in the 1-4 sub-frame 314 of the first frame 310 may be changed to and set in a position of a 1-3 sub-frame of the fourth frame 340.

Specifically, as shown in FIG. 3, according to a location movement of a camera, positions of the sub-frames of each of the feature point 2 302, the feature point 3 303, and the feature point 4 304 are all different. However, feature values around the feature points of each frame are calculated identically. In this instance, the device for detecting a gradual shot transition in a moving picture 200 according to an embodiment of the present invention compares the feature values around the feature points, and determines whether a gradual shot transition occurs. Accordingly, an erroneous determination of an occurrence of the gradual shot transition as in the circumstance illustrated in FIG. 3 may be prevented.

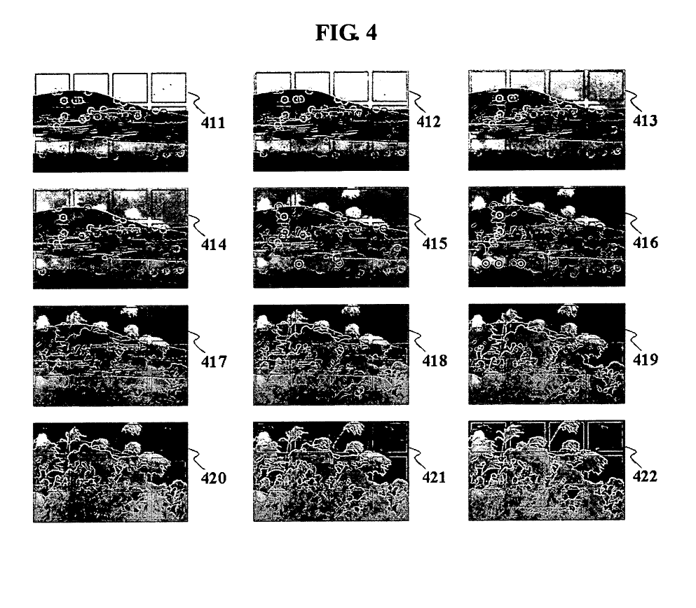

FIG. 4 is a diagram illustrating frames of a moving picture in which a gradual shot transition occurs according to an embodiment of the present invention.

FIG. 4 illustrates a first frame 411, a second frame 412, a third frame 413, a fourth frame 414, a fifth frame 415, a sixth frame 416, a seventh frame 417, a eighth frame 418, a ninth frame 419, a tenth frame 420, a eleventh frame 421, and a twelfth frame 422 in a chronological order.

Referring to FIGS. 2 and 4, according to an operation of a device for detecting a gradual shot transition in a moving picture 200, at least one feature point may be set in each frame. Feature points of the second frame 412 through the twelfth frame 422 may be set by tracking from a feature point which is set in the first frame 411. Also, the feature points may be set by being newly generated for each frame.

Then, the device for detecting a gradual shot transition in a moving picture 200 calculates feature values of feature points for each frame, and compares the feature values of the feature points which are tracked for each of the frames. Accordingly, the device for detecting a gradual shot transition in a moving picture 200 may detect an occurrence of the gradual shot transition. In FIG. 4, the device for detecting a gradual shot transition in a moving picture 200 may determine that the gradual shot transition occurs after the seventh frame 417. Accordingly, frames from the first frame 411 to the sixth frame 416 may be set as one shot, and frames from the seventh frame 417 to the twelfth frame 422 may be set as another shot which the gradual shot transition occurs.

As described above, according to the present embodiment, the gradual shot transition may be detected by local information such as the feature values around the feature points of each frame. Accordingly, a mutual interference between feature values may be alleviated. In this instance, the mutual interference between feature values extracted from frames which do not correspond each other may occur when the gradual shot transition is detected by global information throughout an entire frame.

Also, since a feature point is set by tracking a feature point of a previous frame, an accurate corresponding relationship between feature points of each frame may be determined. Accordingly, a local comparison which selects and uses necessary information around the corresponding feature points may be available. Thus, a processing speed may be improved.

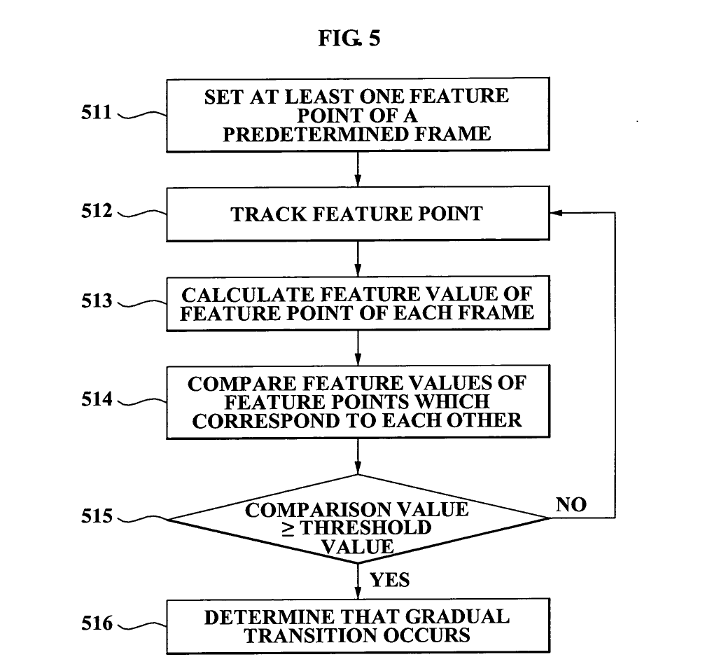

FIG. 5 is a flowchart illustrating a method of detecting a gradual shot transition in a moving picture according to an embodiment of the present invention.

In operation 511, a device for detecting a gradual shot transition in a moving picture according to an embodiment of the present invention sets at least one feature point of a predetermined frame included in the moving picture. In operation 512, after setting the at least one feature point, the device for detecting a gradual shot transition in a moving picture tracks the at least one feature point set in the predetermined frame and sets a feature point of a subsequent frame after the predetermined frame, from the set at least one feature point.

In operation 513, the device for detecting a gradual shot transition in a moving picture calculates feature values around each feature point of each frame, and records the feature values for each frame and feature point in a predetermined memory device. Then, in operation 514, the device for detecting a gradual shot transition in a moving picture compares corresponding feature values of corresponding feature points which are tracked for each of the frames by referring to the memory device.

In operation 515, as a result of the comparison, when the comparison value (i.e., the difference between the compared feature values) is less than a predetermined threshold value, the device for detecting a gradual shot transition in a moving picture returns to operation 512. Also, the device for detecting a gradual shot transition in a moving picture continues to compare feature values of feature points of newly set feature points. In this instance, the newly set feature points are feature points which were set by tracking in a subsequent frame. When the comparison value is greater than or equal to a predetermined threshold value in operation 516, the device for detecting a gradual shot transition in a moving picture determines that a gradual shot transition occurs between the frames.

The method of detecting a gradual shot transition in a moving picture which has been described through FIG. 5 may include all operations according to a configuration of the device for detecting a gradual shot transition in a moving picture which have been described with reference to FIGS. 2 through 4.

The method of detecting a gradual shot transition in a moving picture according to the above-described embodiment of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, waveguides, etc. including a carrier wave transmitting signals specifying the program instructions, data structures, etc. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

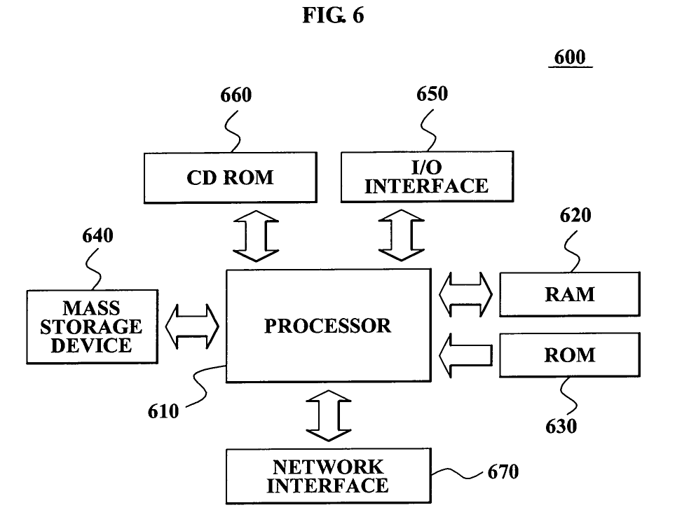

FIG. 6 is an internal block diagram of a general-purpose computer which can be adopted for implementing the method for capturing of the multi-channel image signal according to an embodiment of the present invention.

FIG. 6 is an internal block diagram illustrating a computer apparatus 600 which includes at least one processor 610 connected to a main memory device including a RAM (Random Access Memory) 620 and a ROM (Read Only Memory) 630. The processor 610 is also known as a CPU (central processing unit). The ROM 630 transmits data and instructions to the CPU, and the RAM 620 is generally used for transmitting data and instructions. The RAM 620 and the ROM 630 may include a certain proper form of a computer-readable recording medium. A mass storage device 640 is connected to the processor 610 to provide additional data storage capacity and may be one of number of computer-readable recording mediums. The mass storage device 640 is used for storing programs and data and is an auxiliary memory. A particular mass storage device such as a CD ROM 660 may be used. The processor 610 is connected to at least one input/output (I/O) interface 650 such as a video monitor, a track ball, a mouse, a keyboard, a microphone, a touch-screen type display, a card reader, a magnetic or paper tape reader, a voice or hand-writing recognizer, a joystick, or other known computer input/output unit. The processor 610 may be connected to a wired or wireless communication network via a network interface 670. The procedure of the described method can be performed via the network connection.

The described hardware devices may be configured to act as one or more software modules in order to perform the operations of the present invention.

A device for and a method of detecting a gradual shot transition in a moving picture according to the above-described embodiments of the present invention tracks a feature point which is set in a predetermined frame and set a feature point in another frame, and thereby may compare a substantially corresponding location of each frame.

Also, a device for and a method of detecting a gradual shot transition in a moving picture according to the above-described embodiments of the present invention compares local information including a feature value around a feature point of each frame, determines whether a gradual shot transition occurs, and thereby may prevent a mutual interference of positions which do not correspond to each other when comparing the feature values of an entire frame.

Also, a device for and a method of detecting a gradual shot transition in a moving picture according to the above-described embodiments of the present invention compare a feature value around a feature point which is set in a frame, not a feature value of an entire frame, select necessary information in each frame, and thereby may obtain an accurate result with improved speed.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of detecting a gradual shot transition in a moving picture, the method comprising:
setting at least one feature point of a frame included in the moving picture, tracking the set at least one feature point, and setting a feature point of a subsequent frame, from the tracked at least one feature point;
calculating a feature value corresponding to each feature point of each of the frames; and
comparing corresponding feature values of corresponding feature points which are tracked for each of the frames, and determining that a gradual shot transition between the frames occurs when the comparison value is greater than or equal to a threshold value.

2. The method of claim 1, wherein the setting at least one feature point comprises segmenting the frame into a plurality of sub-frames, and setting the at least one feature point so that each of the sub-frames includes at least one feature point.

3. The method of claim 1, wherein the setting at least one feature point of a predetermined frame, and the tracking and setting of the feature point of a subsequent frame comprises:
setting an M number of feature points of a first frame; and
generating a new feature point of a K^{th} frame so that the K^{th} frame has the M number of feature points, when a number of feature points of the K^{th} frame which is set by tracking the M number of the feature points is less than a predetermined value.

4. The method of claim 1, wherein the feature value is calculated by at least one of a hue-saturation-value (HSV) histogram, a red-green-blue (RGB) histogram, a YCbCr histogram, a hue-lightness-saturation (HLS) histogram, a homogeneous texture, and a gabor texture.

5. The method of claim 1, wherein the comparing corresponding feature values and determining that a gradual shot transition between the frames occurs comprises:
comparing a feature value of a feature point of a first frame with a feature value of a feature point of a K^{th} frame, and calculating a first comparison value; and
determining that the gradual shot transition of the first frame occurs in the K^{th} frame, when the first comparison value is greater than or equal to the threshold value.

6. The method of claim 1, wherein the comparing corresponding feature values and determining that a gradual shot transition between the frames occurs comprises:
comparing a feature value of a feature point of each of first through K^{th} frames with a corresponding feature value of a corresponding feature point of each of 1+N^{th} through K+N^{th} frames for each frame which is separated by an N number of frames, and calculating a first comparison value through a K comparison value; and
determining that the gradual shot transition of the first frame occurs in the 1+N^{th} frame when a predetermined number of comparison values is greater than or equal to the threshold value, among the first comparison value through the K^{th} comparison value.

7. A computer-readable recording medium storing a program for implementing a method of detecting a gradual shot transition in a moving picture, the method comprising:
setting at least one feature point of a frame included in the moving picture, tracking the set at least one feature point, and setting a feature point of a subsequent frame, from the tracked at least one feature point;
calculating a feature value corresponding to each feature point of each of the frames; and
comparing corresponding feature values of corresponding feature points which are tracked for each of the frames, and determining that a gradual shot transition between the frames occurs when the comparison value is greater than or equal to a threshold value.

8. An apparatus for detecting a gradual shot transition in a moving picture, the apparatus comprising:
a feature point control unit setting at least one feature point of a frame included in the moving picture, tracking the set at least one feature point, and setting a feature point of a subsequent frame, from the tracked at least one feature point;
a feature value calculation unit calculating a feature value corresponding to each feature point of each of the frames; and
a gradual transition detection unit comparing corresponding feature values of corresponding feature points which are tracked for each of the frames, and determining that a gradual shot transition between the frames occurs when the comparison value is greater than or equal to a threshold value.

9. The apparatus of claim 8, wherein the frame is a first frame of the moving picture, or is a first frame of a subsequent shot occurring after a predetermined shot transition is detected.

10. The apparatus of claim 8, wherein the feature point control unit sets the at least one feature point using a Harris-Corner detector or a scale invariant feature transform (SIFT) method.

11. The apparatus of claim 8, wherein the feature point control unit tracks feature points using a Lucas-Kanade feature tracker.
